(19) United States
(12) Patent Application Publication
(10) Pub. No.: US 2022/0355959 A1
(43) Pub. Date: Nov. 10, 2022

(54) Quick Self-Making Tool and Pressing Method for Coffee Capsule

(71) Applicant: Xiaofeng LIU, Foshan City (CN)

(72) Inventor: Xiaofeng LIU, Foshan City (CN)

(21) Appl. No.: 17/361,342

(22) Filed: Jun. 29, 2021

(30) Foreign Application Priority Data
May 6, 2021 (CN) 202110492435.2

(51) Int. Cl. B65B 29/02; B65B 67/02; B30B 1/00

(52) U.S. Cl. CPC B65B 29/022; B65B 67/02; B30B 1/00

(57) ABSTRACT

A quick self-making tool for a coffee capsule includes a die holder and a pressing die. A die cavity for containing a capsule shell is formed in the die holder, a sealing film is laid on an opening of the capsule shell, the sealing film seals the opening of the capsule shell through pressing of the pressing die to make the coffee capsule, and a guide piece is arranged on the die holder, and is configured to guide the sealing film to be coaxially aligned with the capsule shell before being pressed and guide up-down vertical movement of the pressing die during pressing. The pressing die evenly press an outer ring of the capsule shell, the sealing effect of the sealing film and the capsule shell is improved, and the situation that the sealing film and the top face of the capsule shell are not combined firmly is avoided.

### TECHNICAL FIELD

The disclosure relates to the field of coffee capsules, and particularly to a quick self-making tool and pressing method for a coffee capsule.

### BACKGROUND

Coffee capsules are popular because of the characteristics of no need of bean grinding, convenience in brewing, consistent taste and quality of brewed coffee and the like, but because the coffee capsules are disposable products, on one hand, the cost is increased, consequently, the price of the coffee capsules is high, and on the other hand, waste and environmental damage are caused to a certain degree. Meanwhile, a coffee machine using the coffee capsules can not adopt self-ground coffee powder, and thus the coffee machine of the type is not suitable for consumers who like grinding coffee powder by themselves. Therefore, a coffee capsule capable of being repeatedly filled with coffee powder for use and a pressing tool used in match with the coffee capsule appear on the market at present. The pressing tool mainly includes a die holder and a pressing die. During use, a capsule shell in the coffee capsule is placed in a die cavity of the die holder, and then an aluminum foil in the coffee capsule is placed at an opening of the capsule shell. Due to the fact that the bottom of the aluminum foil is provided with a bonding material, after the aluminum foil is pressed through the pressing die, the aluminum foil may be bonded to and seal the opening of the capsule shell to form the coffee capsule. But when the pressing tool of the structure is used, the situation that the aluminum foil and the capsule shell as well as the pressing die and the die holder are not aligned up and down easily occurs, therefore, after pressing is completed, a combination portion of the aluminum foil and the capsule shell may be not even, and consequently, breakage, leakage and other problems easily occur, so that the pressing tool needs to be further improved.

### SUMMARY

Aiming at solving the existing problems, the disclosure provides a quick self-making tool for a coffee capsule, which is simple and reasonable in structure. With the quick self-making tool for a coffee capsule, a pressing die may evenly press an outer ring of a capsule shell, and thus the sealing effect of a sealing film and the capsule shell is improved.

The quick self-making tool for a coffee capsule includes a die holder and a pressing die. A die cavity for containing a capsule shell is formed in the die holder. A sealing film is laid on an opening of the capsule shell. The sealing film seals the opening of the capsule shell through pressing of the pressing die to make the coffee capsule. A guide piece is arranged on the die holder or the pressing die, and is configured to guide the sealing film to be coaxially aligned with the capsule shell before being pressed and guide the up-down vertical movement of the pressing die during pressing.

The purpose may also be achieved through the following technical solutions.

The guide piece includes two guide plates which are symmetrically arranged. A guide channel communicating with the die cavity is formed between the guide plates. The guide channel is configured to guide the pressing die when the pressing die vertically moves up and down relative to the die holder.

Each guide plate is provided with a plurality of through grooves which divide the guide plate into a plurality of guide side plates.

The guide piece is a sleeve. A guide channel communicating with the die cavity is formed in the sleeve. The guide channel is configured to guide the pressing die when the pressing die vertically moves up and down relative to the die holder.

The sleeve is provided with a plurality of spacing grooves, and the spacing grooves separate the sleeve into a plurality of guide surrounding plates.

The quick self-making tool for a coffee capsule further includes an annular gland. The annular gland is detachably connected with the edge of the opening of the capsule shell after pressing of the pressing die. The sealing film is tightly pressed between the edge of the opening of the capsule shell and the annular gland.

The edge of the opening of the capsule shell extends outwards to form an outer ring. The outer edge of the outer ring is provided with a buckling brim with a cambered face. The outer edge of the annular gland extends inwards to form a buckling edge matched with the buckling brim. When the buckling edge is connected to the buckling brim in a buckled mode, the edge of the sealing film is tightly pressed between the annular gland and the outer ring and is folded downwards to wrap the outer end face of the buckling brim.

A pressure-bearing table for supporting the outer ring extends along an opening part of the die cavity on the die holder, and an avoiding space for downward buckling of the buckling edge on the buckling brim is reserved between the pressure-bearing table and the guide piece.

An annular pressing face tightly pressing the annular gland is arranged at the bottom of the pressing die. A concave face matched with the top face of the buckling edge is arranged on an outer ring of the annular pressing face. A convex ring with the diameter smaller than or equal to that of an inner ring of the annular gland extends from an inner ring of the annular pressing face.

The guide piece is arranged on the pressing die. An inner thread is formed in the inner end face of the guide piece. An outer thread matched with the inner thread is formed in the outer end face of the pressing die. The pressing die is guided when vertically moving up and down relative to the die holder through threaded connection.

The quick self-making tool for a coffee capsule further includes a hoop. A convex cambered face is arranged on an inner ring of the hoop. A stop face is inclined arranged above the convex cambered face. A concave cambered face matched with the convex cambered face is arranged on the outer side wall, close to the opening, of the capsule shell. An abutting face which is configured to open the hoop along the convex cambered face during pressing and is in limiting fit with the stop face after pressing is inclined arranged above the concave cambered face. When the hoop hoops the concave cambered face, the edge of the sealing film is folded downwards and tightly pressed between the convex cambered face and the concave cambered face.

A positioning ring matched with the hoop extends from the bottom of the pressing die, and an inner ring face in interference fit with the hoop and a guide inclined face configured to guide the hoop into the inner ring face are arranged on an inner ring of the positioning ring.

A plurality of prying openings configured to detach the hoop are formed in the outer side wall of the capsule shell in the circumferential direction.

A holding portion arranged in the circumferential direction extends from the outer end face of the pressing die, and the top of the guide piece abuts against the holding portion in a limiting mode.

A pressing method for a coffee capsule includes the following steps.

In S1, coffee powder or the like are poured into a capsule shell.

In S2, the capsule shell containing the coffee powder is placed into a die cavity on a die holder to be positioned, a sealing film is placed at an opening of the capsule shell, and the sealing film and the capsule shell are enabled to be coaxially aligned through a guide piece.

In S3, a hoop is placed on the bottom of a pressing die through interference fit with a positioning ring, a user may selectively press the hoop onto a bearing plane through the pressing die, and it is guaranteed that the hoop is fixed horizontally on the bottom of pressing die.

In S4, the pressing die with the hoop is placed into the guide piece, so that the pressing die and the die holder form a vertical up-down relationship.

In S5, downward acting force is applied to the pressing die, the hoop is pressed to hoop the outer side wall of the capsule shell and separate from the positioning ring, so that the edge of the sealing film is tightly clamped between the outer side wall of the capsule shell and the hoop, and the sealing film is fixed at the opening of the capsule shell to make the coffee capsule.

In S6, the pressing die is removed and the coffee capsule is taken out of the die cavity.

The beneficial effects of the disclosure are as follows.

The self-making tool for a coffee capsule is simple in structure, convenient to use, free of occupation of redundant space and low in production cost; through the guide piece, the sealing film may be laid in the middle of the opening of the capsule shell before pressing; and in the pressing process, the pressing die moves downwards in the vertical direction, so that the pressing die may evenly press the outer ring of the capsule shell, thus the sealing effect of the sealing film and the capsule shell is improved, and the situation that the sealing film and the top face of the capsule shell are not combined firmly, leading to a notch at the combining point of the sealing film and the top face of the capsule shell is avoided.

### BRIEF DESCRIPTION OF THE DRAWINGS

FIG. 1 is a schematic structural diagram of an exploded view of the disclosure.

FIG. 2 is a schematic structural diagram of a guide piece according to a first embodiment of the disclosure

FIG. 3 is a schematic structural diagram of a guide piece according to a second embodiment of the disclosure.

FIG. 4 is a schematic structural diagram of a guide piece according to third embodiment of the disclosure.

FIG. 5 is a schematic structural diagram of a guide piece according to a fourth embodiment of the disclosure.

FIG. 6 is a schematic structural diagram of a sectional view before pressing of the disclosure.

FIG. 7 is a schematic structural diagram of an enlarged structure of B in FIG. 6.

FIG. 8 is a schematic structural diagram of a sectional view after pressing of the disclosure.

FIG. 9 is a schematic structural diagram of an enlarged structure of C in FIG. 8.

FIG. 10 is a first schematic structural diagram of a screw-pressed view of the disclosure.

FIG. 11 is a second schematic structural diagram of a screw-pressed view of the disclosure.

FIG. 12 is a schematic structural diagram of a pressing plate of the disclosure.

FIG. 13 is a schematic structural diagram of a sectional view before hoop pressing of the disclosure.

FIG. 14 is a schematic structural diagram of a sectional view after hoop pressing of the disclosure.

FIG. 15 is schematic structural diagram of an enlarged structure of D in FIG. 14.

FIG. 16 is a schematic structural diagram of a flanging arranged on the hoop of the disclosure.

FIG. 17 is a schematic structural diagram of prying openings of the disclosure.

### DETAILED DESCRIPTION OF THE EMBODIMENTS

The disclosure will be further described below in combination with the drawings and the embodiments.

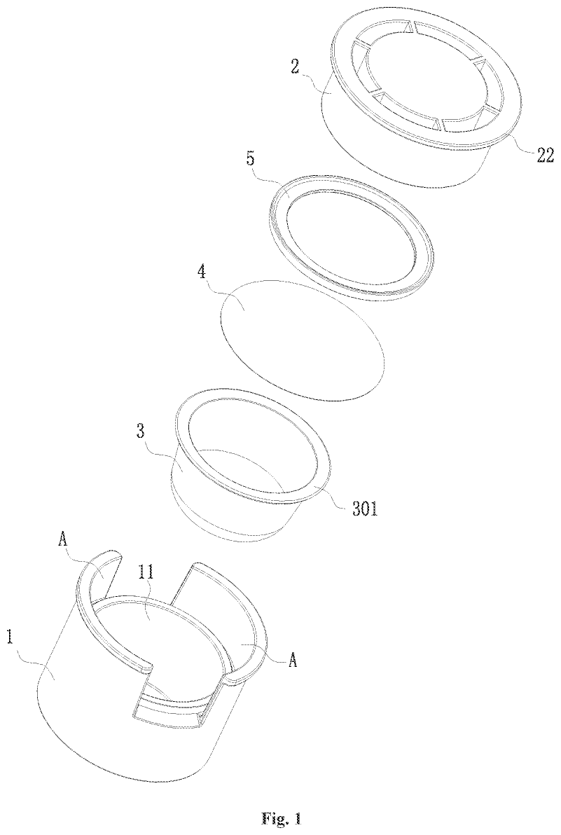

As shown in FIG. 1, a quick self-making tool for a coffee capsule includes a die holder 1 and a pressing die 2, a die cavity 11 for containing a capsule shell 3 is formed in the die holder 1, a sealing film 4 is laid on an opening of the capsule shell 3, the sealing film 4 seals the opening of the capsule shell 3 through pressing of the pressing die 2 to make the coffee capsule, and a guide piece A is arranged on the die holder 1 or the pressing die 2 and configured to guide the sealing film 4 to be coaxially aligned with the capsule shell 3 before being pressed and guide up-down vertical movement of the pressing die 2 during pressing.

According to the self-making tool of the structure, the sealing film 4 may be laid in the middle of the opening of the capsule shell 3 before pressing through the guide piece A, in the pressing process, the pressing die 2 moves downwards in the vertical direction, then the pressing die 2 may evenly press an outer ring 301 of the capsule shell 3, so that the sealing effect of the sealing film 4 and the capsule shell 3 is improved, and the situation that the sealing film 4 and the top face of the capsule shell 3 are not combined firmly, leading to a notch at the combining point of the sealing film 4 and the top face of the capsule shell 3 is avoided. The sealing film 4 may be connected with the opening of the capsule shell 3 in a sealing mode through a bonding material or indentation, buckling and other connecting modes.

Furthermore, the embodiments of the guide piece A are as follows.

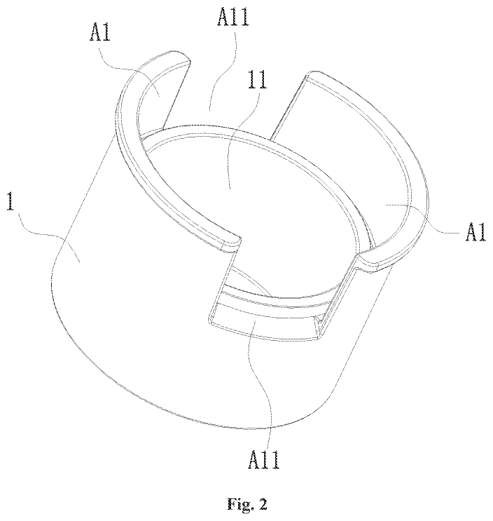

According to a first embodiment, as shown in FIG. 2, a guide piece A includes two guide plates A1 which are symmetrically arranged, a guide channel communicating with a die cavity 11 is formed between the guide plates A1, the guide channel is configured to guide a pressing die 2 when the pressing die 2 vertically moves up and down relative to the die holder 1 through clearance fit between the guide channel and the pressing die 2, and it is guaranteed that the pressing die 2 may coaxially move relative to a die holder 1. In the embodiment, both the die holder 1 and the pressing die 2 are of round structures, so that the guide plates A1 are of arc-shaped structures, the guide plates A1 are arranged on the side edge of the die holder 1, and through the two guide plates A1, the pressing die 2 may be kept at a vertical position and may evenly press an opening of a capsule shell 3.

Two notches A11 communicating with the guide channel are formed between the two guide plates A1, so that before pressing, a consumer may clamp the capsule shell 3 with two fingers until the capsule shell 3 is placed into the bottom of the die cavity 11, and after pressing, a coffee capsule formed after pressing may be taken out of the die cavity 11 in the same mode.

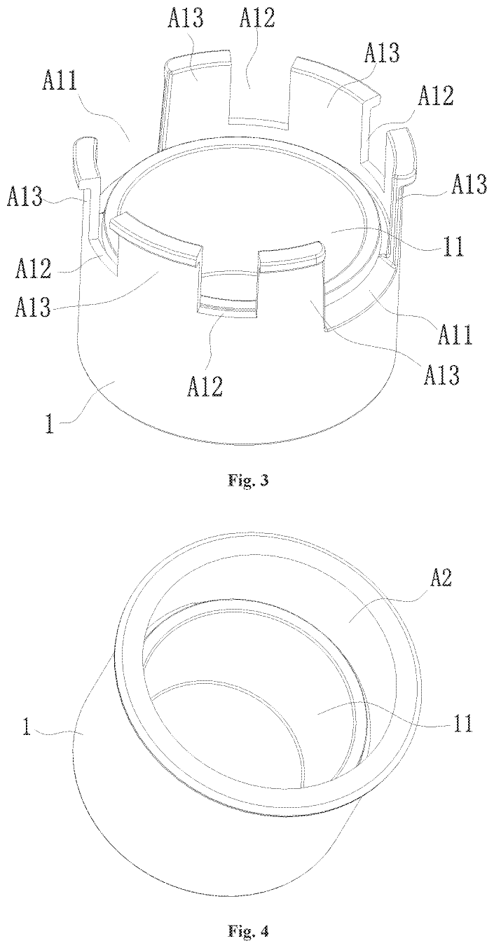

According to a second embodiment, which is evolved on the basis of the first embodiment, as shown in FIG. 3, a plurality of through grooves A12 are formed in each guide plate A1, the guide plate A1 is separated into a plurality of guide side plates A13 through the through grooves A12, and the through grooves A12 can increase the number of notches A11, so that the coffee capsule may be taken and placed more easily.

According to a third embodiment, as shown in FIG. 4, the guide piece A is a sleeve A2, a guide channel communicating with a die cavity 11 is formed in the sleeve A2, the guide channel guides a pressing die 2 when the pressing die 2 vertically moves up and down relative to a die holder 1 through clearance fit between the guide channel and the pressing die 2, and it is guaranteed that the pressing die 2 may coaxially move relative to the die holder 1. The sleeve A2 may be of a closed ring shape or a circular arc shape with a single notch A11.

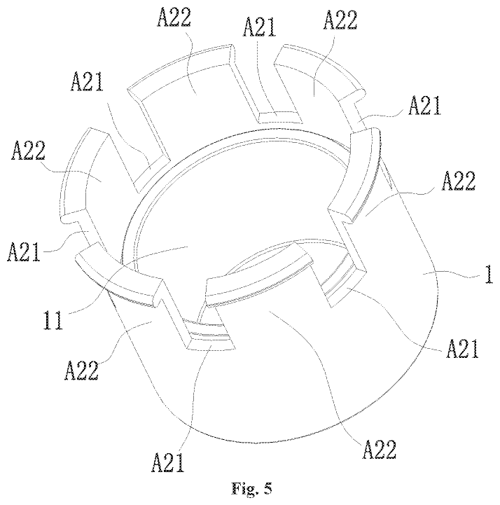

According to a fourth embodiment, which is evolved on the basis of the third embodiment, as shown in FIG. 5, a sleeve A2 is provided with a plurality of spacing grooves A21, and the spacing grooves A21 separate the sleeve A2 into a plurality of guide surrounding plates A22.

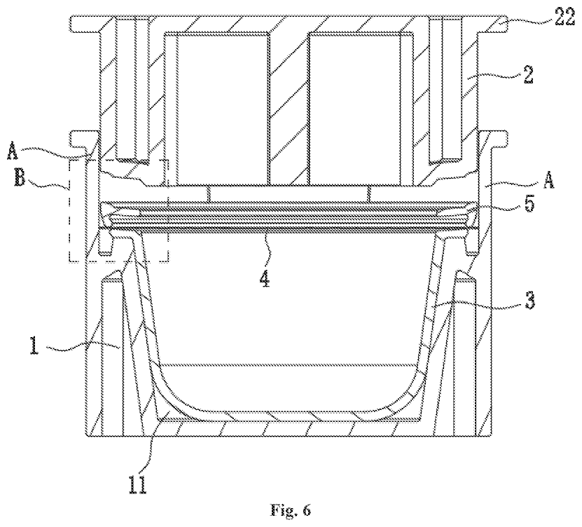

Furthermore, as shown in FIGS. 6 to 9:

the quick self-making tool for a coffee capsule further includes an annular gland 5 which is detachably connected with the edge of an opening of a capsule shell 3 after being pressed by a pressing die 2, a sealing film 4 is tightly pressed between the edge of the opening of the capsule shell 3 and the annular gland 5, namely, with such structure, the opening of the capsule shell 3 is sealed with the sealing film 4 through the annular gland 5, so that fixing of a bonding material is saved, and a coffee capsule is more sanitary. In addition, the coffee capsule may be opened at any time, the sealing film 4 may be separated from the capsule shell 3 after the annular gland 5 is manually detached, washing may be realized after use or the coffee capsule may be rapidly filled with coffee powder of the next round, and then repeated use is realized.

Before pressing, the sealing film 4 and the annular gland 5 are sequentially placed at the opening of the capsule shell 3, and the annular gland 5 is in clearance fit with the guide piece A when placed, so that the annular gland 5 vertically moves up and down in the guide channel.

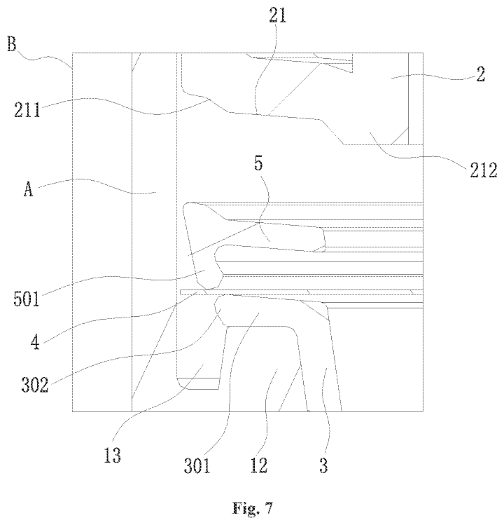

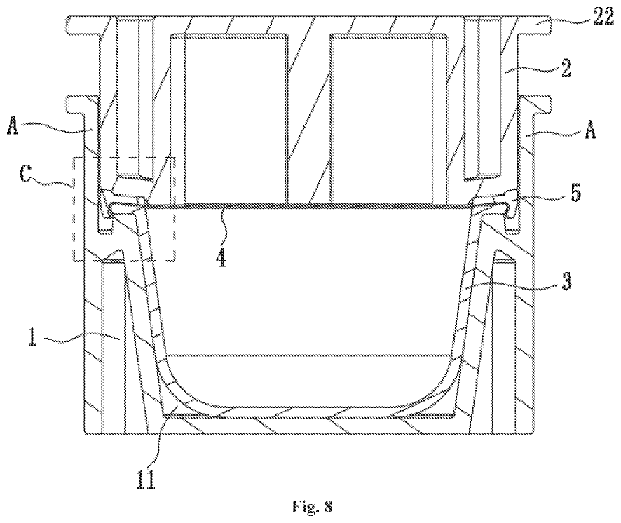

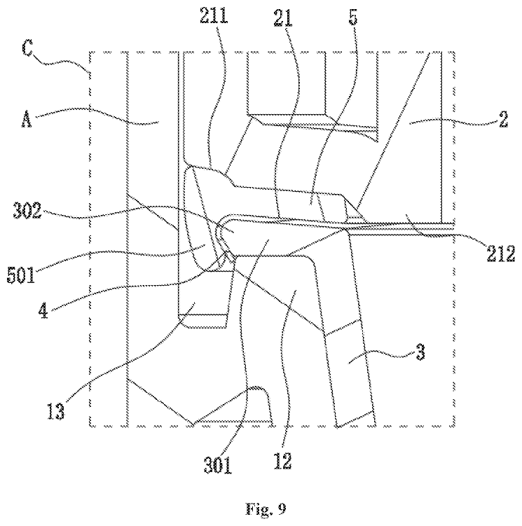

Furthermore, as shown in FIG. 7, the edge of the opening of the capsule shell 3 extends outwards to form an outer ring 301, the outer edge of the outer ring 301 is provided with a buckling brim 302 with a cambered face, and the outer edge of the annular gland 5 extends inwards to form a buckling edge 501 matched with the buckling brim 302. When the buckling edge 501 is connected to the buckling brim 302 in a buckled mode, the edge of the sealing film 4 is tightly pressed between the annular gland 5 and the outer ring 301, and meanwhile, the edge of the sealing film 4 is folded downwards to wrap the outer end face of the buckling brim 302. With such structure, buckling connection of the buckling brim 302 and the buckling edge 501 may be realized when the pressing die 2 presses downwards. The structure is simple, installing and detaching are convenient, the sealing effect of the coffee capsule is good, and the sealing film 4 may be evenly pressed on the outer ring 301 through the annular gland 5 (specifically as shown in FIG. 8 and FIG. 9).

Furthermore, a pressure-bearing table 12 for supporting the outer ring 301 extends along an opening part of a die cavity 11 on the die holder 1, an avoiding space 13 for downward buckling of the buckling edge 501 on the buckling brim 302 is reserved between the pressure-bearing table 12 and the guide piece A, the capsule shell 3 may be horizontally placed through the pressure-bearing table 12, and in addition, when the buckling brim 302 is buckled with the buckling edge 501, the avoiding space 13 enables the buckling edge 501 to have enough room for downward displacement.

Furthermore, as shown in FIG. 8 and FIG. 9, an annular pressing face 21 for tightly pressing the annular gland 5 is arranged at the bottom of the pressing die 2, a concave face 211 matched with the top face of the buckling edge 501 is arranged on an outer ring of the annular pressing face 21, and a convex ring 212 with the diameter smaller than or equal to that of an inner ring of the annular gland 5 extends from an inner ring of the annular pressing face 21. In the actual use process of the guide piece A and the pressing die 2, in order to ensure that the pressing die 2 may move up and down smoothly, a gap is difficult to avoid, so that the annular gland 5 may inclines slightly when being placed into a guide channel. The annular gland 5 and the capsule shell 3 are not coaxial, the convex ring 212 is in a conical shape, the convex ring 212 is in contact with the annular gland 5 and then gradually enters the inner ring of the annular gland 5 to perform centering adjustment on the annular gland 5, so that the annular gland 5 is vertically straightened, and the annular gland 5 and the capsule shell 3 are coaxial.

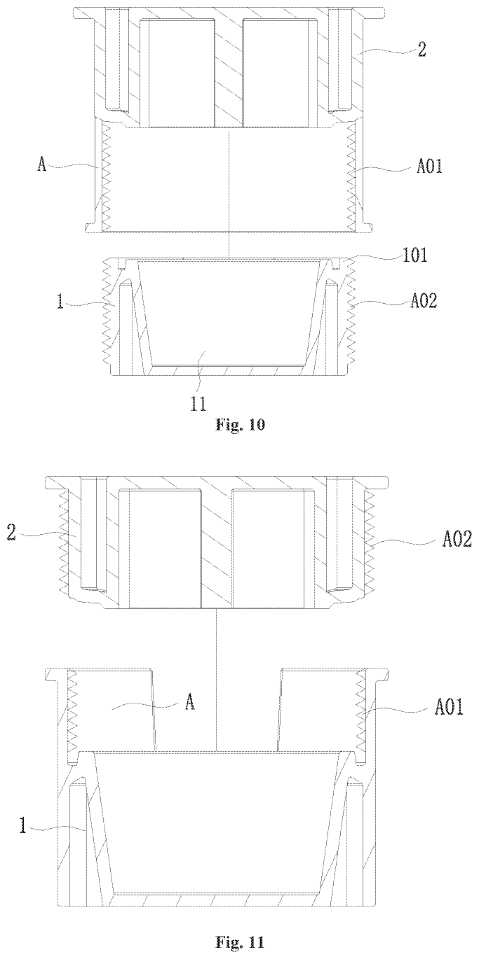

Furthermore, as shown in FIG. 10 and FIG. 11, the guide piece A is arranged on the pressing die 2, an internal thread A01 is formed in the inner end face of the guide piece A, an external thread A02 matched with the internal thread A01 is formed in the outer end face of the pressing die 2, and the pressing die 2 is vertically guided up and down and tightly pressed with the die holder 1 through thread fit. Downward pressing force can be converted through thread rotation, and the pressing force is large. As the guide piece A plays a role in vertically guiding the pressing die 2 up and down and also plays a role in positioning the sealing film 4 when the sealing film 4 is placed on the opening of the capsule shell 3, when the guide piece A is arranged on the pressing die 2, a convex ring 101 for positioning the sealing film 4 extends from the top face of the die holder 1 along the periphery of the die cavity 11.

In addition, when the guide piece A is arranged on the die holder 1, thread fit may be achieved as well, the inner thread A01 is formed in the inner end face of the guide piece A as well, and the outer thread A02 is formed in the outer end face of the pressing die 2.

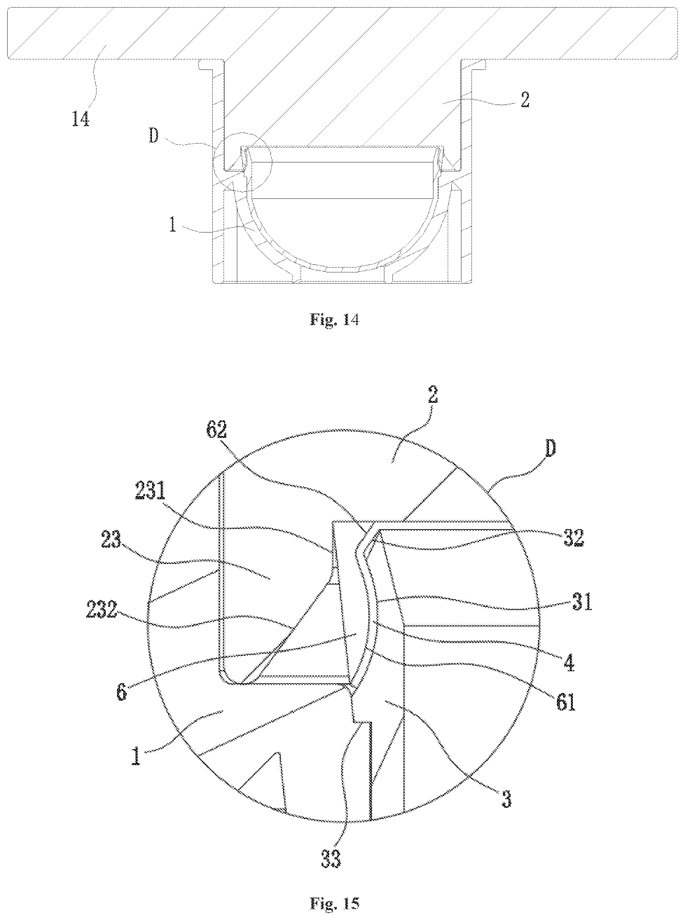

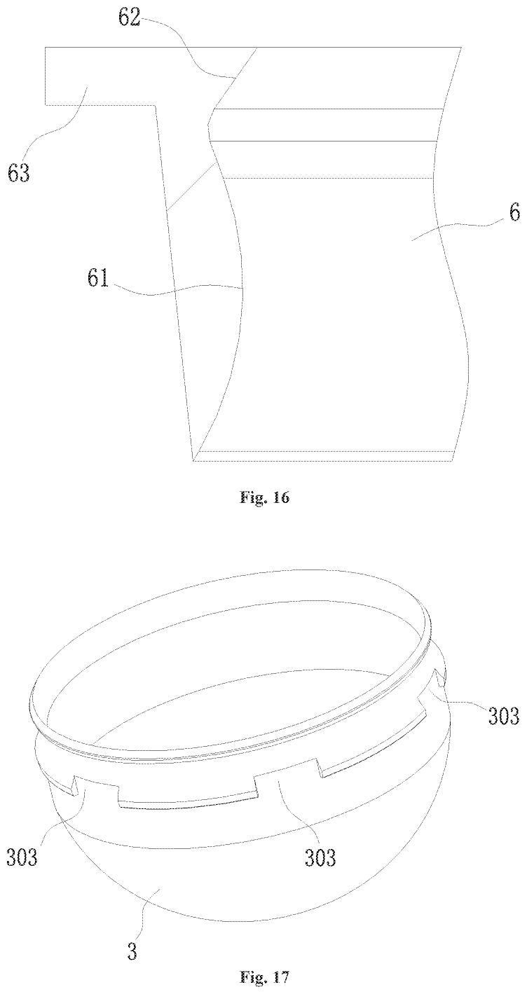

Furthermore, as shown in FIGS. 13 to 16, a hoop 6 is further included, a convex cambered face 61 is arranged on an inner ring of the hoop 6, a stop face 62 is inclined arranged above the convex cambered face 61, a concave cambered face 31 matched with the convex cambered face 61 is arranged on the outer side wall, close to the opening, of the capsule shell 3, and an abutting face 32 which is configured to open the hoop 6 along the convex cambered face 61 during pressing and is in limiting fit with the stop face 62 after pressing is inclined arranged above the concave cambered face 31. When the hoop 6 hoops the concave cambered face 31, the edge of the sealing film 4 is folded downwards and tightly pressed between the convex cambered face 61 and the concave cambered face 31. By adopting the structure to form the coffee capsule, the top face of the capsule shell 3 is only covered with the sealing film 4, so that the top face of the coffee capsule is kept flat and smooth.

When the structure is used, the sealing film 4 is placed at the opening of the capsule shell 3, at the moment, the hoop 6 bears downward acting force, the convex cambered face 61 makes contact with the abutting face 32 first, the convex cambered face 61 slides along the abutting face 32 to make the hoop 6 be opened, so that the diameter of the hoop 6 is increased, then the edge of the sealing film 4 is bent downwards, after the convex cambered face 61 crosses the abutting face 32, the hoop 6 shrinks, the convex cambered face 61 is tightly pressed on the concave cambered face 31 of the outer side wall of the capsule shell 3 to tightly press the edge of the sealing film 4, the stop face 62 presses against the abutting face 32 to limit the hoop 6, and the stop face 62 and the abutting face 32 enable the sealing film 4 to have inclined transition during bending, so that the problem that the sealing film 4 is prone to breakage due to single large-angle bending is solved.

A supporting step face 33 for supporting the capsule shell 3 on the top face of the die holder 1 is arranged at the lower part of the concave cambered face 31.

In addition, the coffee capsule of the structure may be recycled, so that a flanging 63 may extend from the outer ring of the hoop 6 to increase the operation location, and the hoop 6 is easier to detach when the hoop 6 is detached from the capsule shell 3 by means of the flanging 63.

A positioning ring 23 matched with the hoop 6 extends from the bottom of the pressing die 2, an inner ring face 231 in interference fit with the hoop 6 and a guide inclined face 232 configured to guide the hoop 6 into the inner ring face 231 are arranged on an inner ring of the positioning ring 23, the hoop 6 can be fixed in the positioning ring 23 before pressing, and it is guaranteed that the hoop 6 is placed horizontally and is coaxially aligned with the capsule shell 3 and sealing film 4 during pressing.

Furthermore, with reference to FIG. 17, a plurality of prying openings 303 configured to detach the hoop 6 are formed in the outer side wall of the capsule shell 3 in the circumferential direction, when the coffee capsule needs to be recycled, a user may insert a tool (such as a slotted screwdrive and other similar tools) into the prying openings 303 to pry the hoop out of the capsule shell 3, the structure is simple, and the detaching is convenient.

Furthermore, a holding portion 22 arranged in the circumferential direction extends from the outer end face of the pressing die 2, the top of the guide piece A abuts against the holding portion 22 in a limiting mode, a consumer may conveniently lift the pressing die 2 through the holding portion 22, and limiting is realized through matched use of the top of the guide piece A.

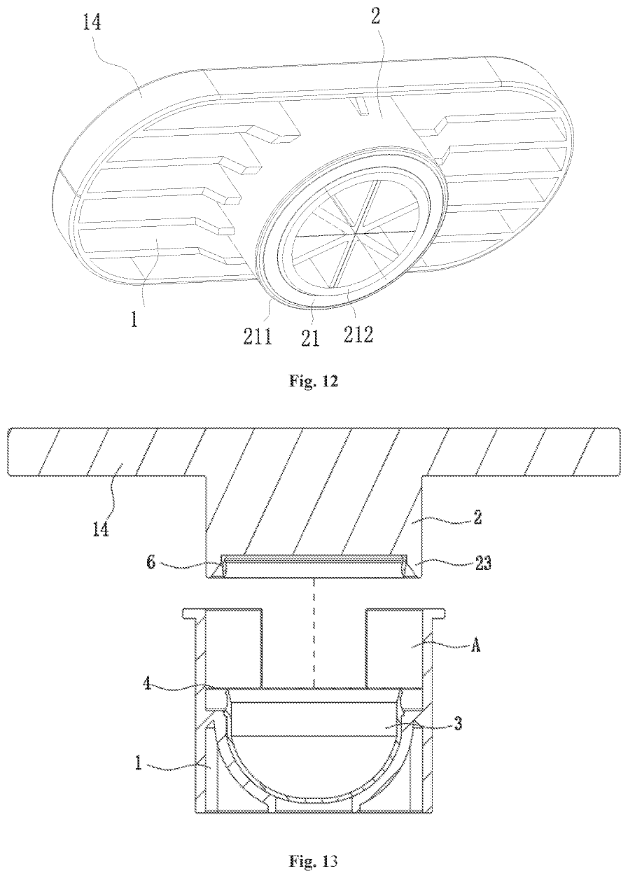

In addition, with reference to FIG. 12, a pressing plate 14 extends in the horizontal direction of the outer side of the pressing die 2, the stressing area may be increased through the pressing plate 14. In the embodiment, the pressing plate 14 is strip-shaped, the pressing die is arranged in the center of the pressing plate, due to the pressing plate 14 of the structure, the consumer may exert force on the pressing plate 14 by hands, so that the downward pressing force of the pressing die 2 is increased, and the pressing effect of the coffee capsule is more ideal. In addition, a plurality of structural reinforcement ribs 141 connected to the pressing die 2 extend from the bottom of pressing plate 14, and the structural reinforcement ribs 141 may increase the strength of the pressing plate, so that the bending or breaking problem caused by excessive acting force may be avoided.

The sealing film 4 may be an aluminum foil.

A pressing method for a coffee capsule includes the following steps.

In S1, coffee powder or the like are poured into a capsule shell 3.

In S2, the capsule shell 3 containing the coffee powder is placed into a die cavity on a die holder 1 to be positioned, a sealing film 4 is placed at an opening of the capsule shell 3, and the sealing film 4 and the capsule shell 3 are enabled to be coaxially aligned through a guide piece A.

In S3, a hoop 6 is placed on the bottom of a pressing die 2 through interference fit with a positioning ring 23, a user may selectively press the hoop 6 onto a bearing plane through the pressing die 2, and it is guaranteed that the hoop 6 is fixed horizontally on the bottom of pressing die 2.

In S4, the pressing die 2 with the hoop 6 is placed into the guide piece A, so that the pressing die 2 and the die holder 11 form a vertical up-down relationship.

In S5, downward acting force is applied to the pressing die 2, the hoop 6 is pressed to hoop the outer side wall of the capsule shell 3 and separate from the positioning ring 23, so that the edge of the sealing film 4 is tightly clamped between the outer side wall of the capsule shell 3 and the hoop 6, and the sealing film 4 is fixed at the opening of the capsule shell 3 to make the coffee capsule.

In S6, the pressing die 2 is removed and the coffee capsule is taken out of the die cavity.

The foregoing are preferred embodiments of the disclosure, and the basic principles, main features and advantages of the disclosure are shown and described. It will be understood by those skilled in the art that the disclosure is not limited to the embodiments described above, which are merely illustrative of the principles of the disclosure, various changes and modifications may be made without departing from the spirit and scope of the disclosure, such changes and modifications are intended to fall within the scope of the disclosure as claimed, as defined by the appended claims and equivalents thereof

What is claimed is:

1. A quick self-making tool for a coffee capsule, comprising a die holder and a pressing die, wherein a die cavity for placing a capsule shell is arranged in the die holder, a sealing film is laid on an opening of the capsule shell, the sealing film seals the opening of the capsule shell by pressing of the pressing die to make the coffee capsule, wherein the die holder or the pressing die is provided with a guide piece, the guide piece is configured to guide the sealing film to be coaxially aligned with the capsule shell before being pressed and guide up-down vertical movement of the pressing die during pressing.

2. The quick self-making tool for a coffee capsule as claimed in claim 1, wherein the guide piece comprises two guide plates which are symmetrically arranged, a guide channel communicating with the die cavity is formed between the guide plates, and the guide channel is configured to guide the pressing die when the pressing die vertically moves up and down relative to the die holder.

3. The quick self-making tool for a coffee capsule as claimed in claim 2, wherein the guide plate is provided with a plurality of through grooves, and the through grooves divide the guide plate into a plurality of guide side plates.

4. The quick self-making tool for a coffee capsule as claimed in claim 1, wherein the guide piece is a sleeve, a guide channel communicating with the die cavity is formed in the sleeve, and the guide channel is configured to guide the pressing die when the pressing die vertically moves up and down relative to the die holder.

5. The quick self-making tool for the coffee capsule as claimed in claim 4, wherein the sleeve is provided with a plurality of spacing grooves, and the spacing grooves separate the sleeve into a plurality of guide surrounding plates.

6. The quick self-making tool for a coffee capsule as claimed in claim 1, further comprising an annular gland, the annular gland being pressed by the pressing die and then connected with the edge of the opening of the capsule shell, and the sealing film being tightly pressed between the edge of the opening of the capsule shell and the annular gland.

7. The quick self-making tool for a coffee capsule as claimed in claim 6, wherein the edge of the opening of the capsule shell extends outwards to form an outer ring, the outer edge of the outer ring is provided with a buckling brim with a cambered face, the outer edge of the annular gland extends inwards to form a buckling edge matched with the buckling brim, and when the buckling edge is buckled on the buckling brim, the edge of the sealing film is tightly pressed between the annular gland and the outer ring and is folded downwards to wrap the outer end face of the buckling brim.

8. The quick self-making tool for a coffee capsule as claimed in claim 7, wherein a pressure-bearing table for supporting the outer ring extends along the opening part of the die cavity on the die holder, and an avoiding space for downward buckling of the buckling edge on the buckling brim is reserved between the pressure-bearing table and the guide piece.

9. The quick self-making tool for a coffee capsule as claimed in claim 6, wherein the bottom of the pressing die is provided with an annular pressing face for pressing the annular gland, an outer ring of the annular pressing face is provided with a concave face matched with the top face of the buckling edge, and a convex ring with the diameter smaller than or equal to that of an inner ring of the annular gland extends from an inner ring of the annular pressing face.

10. The quick self-making tool for a coffee capsule as claimed in claim 2, wherein the guide piece is arranged on the pressing die, the inner end face of the guide piece is provided with an internal thread, the outer end face of the die holder is provided with an external thread matched with the internal thread, and the pressing die is vertically guided up and down through thread fit and tightly pressed with the die holder.

11. The quick self-making tool for a coffee capsule as claimed in claim 4, wherein the guide piece is arranged on the pressing die, the inner end face of the guide piece is provided with an internal thread, the outer end face of the die holder is provided with an external thread matched with the internal thread, and the pressing die is vertically guided up and down through thread fit and tightly pressed with the die holder.

12. The quick self-making tool for a coffee capsule as claimed in claim 1, further comprising a hoop, an inner ring of the hoop is provided with a convex cambered face, a stop face is inclined arranged above the convex cambered face, a concave cambered face matched with the convex cambered face is arranged on the outer side wall, close to the opening, of the capsule shell, an abutting face which is configured to open the hoop along the convex cambered face during pressing and is in limiting fit with the stop face after pressing is inclined arranged above the concave cambered face, and when the hoop hoops the concave cambered face, the edge of the sealing film is folded downwards and pressed between the convex cambered face and the concave cambered face.

13. The quick self-making tool for a coffee capsule as claimed in claim 12, wherein a positioning ring matched with the hoop extends from the bottom of the pressing die, and an inner ring face in interference fit with the hoop and a guide inclined face for guiding the hoop into the inner ring face are arranged on an inner ring of the positioning ring.

14. The quick self-making tool for a coffee capsule as claimed in claim 12, wherein a plurality of prying openings configured to detach the hoop are formed in the outer side wall of the capsule shell in the circumferential direction.

15. The quick self-making tool for the coffee capsule as claimed in claim 1, wherein a holding portion arranged in the circumferential direction extends from the outer end face of the pressing die, and the top of the guide piece abuts against the holding portion in a limiting mode.

16. A pressing method suitable for claim 13, comprising:
S1, pouring coffee powder or the like into a capsule shell;
S2, placing the capsule shell containing the coffee powder into a die cavity on a die holder to be positioned, placing a sealing film at an opening of the capsule shell, and enabling the sealing film and the capsule shell to be coaxially aligned through a guide piece;
S3, placing a hoop on the bottom of a pressing die through interference fit with a positioning ring, wherein a user may selectively press the hoop onto a bearing plane through the pressing die, and it is guaranteed that the hoop is fixed horizontally on the bottom of pressing die;
S4, placing the pressing die with the hoop into the guide piece, so that the pressing die and the die holder form a vertical up-down relationship;
S5, applying downward acting force to the pressing die, and pressing the hoop to hoop the outer side wall of the capsule shell and separate from the positioning ring, so that the edge of the sealing film is tightly clamped between the outer side wall of the capsule shell and the hoop, and the sealing film is fixed at the opening of the capsule shell to make the coffee capsule; and
S6, removing the pressing die and taking the coffee capsule out of the die cavity.
